(19) United States
(12) Patent Application Publication
(10) Pub. No.: US 2010/0046790 A1
(43) Pub. Date: Feb. 25, 2010

(54) METHOD AND SYSTEM FOR GENERATING A SYMBOL IDENTIFICATION CHALLENGE

(76) Inventors: Anthony R. Koziol, Gainesville, FL (US); Jason D. Koziol, Naperville, IL (US)

Correspondence Address: Law Office of Daniel W. Roberts, 904 Topaz Street, Superior, CO, 80027, US

(21) Appl. No.: 12/196,389

(22) Filed: Aug. 22, 2008

(51) Int. Cl. G06K 9/00

(52) U.S. Cl. 382/100

(57) ABSTRACT

Provided is a system and method for generating a symbol identification challenge. The method includes receiving a plurality of symbols, e.g. a base symbol and a noise symbol. A first visual property and a second visual property is then applied to each received symbol. Each symbol is then transformed by transitioning the first visual property to the second visual property and the second visual property to the first visual property. A plurality of views is then generated by transitioning between the transformations of each symbol. An associated system for performing the method is also provided.

### FIELD OF THE INVENTION

The present invention relates generally to data security and more particularly to methods and systems for generating a representation of a symbol that poses an identification challenge.

### BACKGROUND

Sensitive data, such as for example, email addresses, phone numbers, residence addresses, usernames, user passwords, social security numbers, credit card numbers and/or other personal information are routinely stored on computer systems. Individuals often use personal computers to store bank records and personal address listings. Web servers frequently store personal data associated with different groups, such as clients and customers. In many cases, such computers are coupled to the Internet or other network which is accessible to other users and permits data exchange between different computers and users of the network and systems.

Connectivity to the Internet or other network often exposes computer systems to malicious autonomous software applications or automated agents. Automated agents are typically generated by autonomous software applications that operate to “appear” as an agent for a user or a program. Real and/or virtual machines are used to generate automated agents that simulate human user activity and/or behavior to search for and gain illegal access to computer systems connected to the Internet or other network, retrieve data from the computer systems and generate databases of culled data for unauthorized use by illegitimate users.

Automated agents typically consist of one or more sequenced operations. The sequence of operations can be executed by a real or virtual machine processor to enact the combined intent of one or more developers and/or deployers of the sequence of operations. The size of the sequence of operations associated with an automated agent can range from a single machine coded instruction to a distributed operating system running simultaneously on multiple virtual processing units. An automated agent may consist of singular agents, independent agents, an integrated system of agents and agents composed of sub-agents where the sub-agents themselves are individual automated agents. Examples of such automated agents include, but are not limited to, viruses, Trojans, worms, bots, spiders, crawlers and keyloggers.

The increased use of computer systems that are communicatively coupled to the Internet or other networks to store and manipulate different forms of sensitive data has generated a need to format sensitive data into a form that is recognizable to a human user while posing an identification challenge to an automated agent. Storing and/or transmitting sensitive data in such a format enables human users to access the data for legitimate reasons while making it a challenge for automated agents to access the data for illegitimate reasons.

In some prior art systems, static images of sensitive data are represented in a format that includes one or more different noise components. For example, noise components in the form of various types of deformations and/or distortions are introduced into the static image representation of the sensitive data. For example, in a CAPTCHA (Completely Automated Public Turing Test to Tell Computers and Humans Apart) representation of data, noise is deliberately and/or strategically integrated into the static image representation of the sensitive data in an attempt to protect the sensitive data from automated agents that may gain unauthorized access to the data.

Often the noise element is provided in a systematic way which can be determined by review and analysis. Once understood and/or otherwise identified the noise element can be removed and optical character recognition or other methodology may be employed to understand the sensitive data.

Attempts to provide animated CAPTCHA representations of data have thus far also involved the introduction of noise elements into the sensitive data, but again seem to rely on simple elements that can be identified and removed to reveal the intended sensitive data. Indeed, in many CAPTCHA systems there is at least one key view that provides a substantially clear view of all elements forming the sensitive data. In other systems there are repeating key views that provide substantially clear views of each element or sub-sets of the elements—such that when taken as a whole the sensitive data is revealed in its entirety.

Unfortunately, continuous advances in optical character recognition technologies have operated to defeat many of the different static and animated CAPTCHA representations of sensitive data.

Hence there is a need for a method and system that is capable of generating a representation of a symbol that poses an identification challenge.

### SUMMARY

This invention provides a method and system for generating a representation symbol as an identification challenge.

In particular, and by way of example only, according to one embodiment of the present invention, a method of generating a symbol identification challenge for an automated agent, the method including: receiving a plurality of symbols; for each received symbol, applying a first visual property and a second visual property to the symbol; transforming each received symbol by, for each received symbol, transitioning the first visual property to the second visual property and the second visual property to the first visual property; and generating a plurality of views by transitioning between the transformations of each received symbol.

In another embodiment, provided is a method of generating a symbol identification challenge for an automated agent, the method including: receiving a base symbol; generating a representation symbol by imposing a pixel grid upon the base symbol, each pixel receiving an initial value as foreground or background; receiving at least one noise symbol and imposing the pixel grid upon the noise symbol, each pixel having an initial value as foreground or background; generating a first stream by transitioning each pixel in the representation symbol through a luminance range defined by the foreground and the background; generating a second stream by transitioning each pixel in the noise symbol through a luminance range defined by the foreground and the background; generating a plurality of views by combining the first stream and the second stream.

In yet another embodiment, provided is a method of generating a symbol identification challenge for an automated agent, the method including: receiving a base symbol; generating a representation symbol by applying a first foreground property and a first background property to the base symbol; selecting at least one noise symbol, the noise symbol having a second foreground property and a second background property; generating a plurality of views by: transforming the representation symbol by transitioning the first foreground property to the first background property and the first background property to the first foreground property; transforming the noise symbol by transitioning the second foreground property to the second background property and the second background property to the second foreground property; combining the transition of the representation symbol with the transition of the noise symbol.

Further still, in yet another embodiment, provided is a system for generating a representation of a symbol, including: a system for generating a representation of a symbol that poses an identification challenge for an automated agent, the system including: a receiver structure and arranged with an input device for permitting at least one first symbol to be received; a database providing at least one second symbol; an initializer structured and arranged to initialize each first and second symbol by applying to each symbol a foreground property and a background property; a transitioner structured and arranged to transition each symbol between the foreground property and the background property; and a view generator structured and arranged to generate a plurality of views by combining the transitions of the symbols.

### BRIEF DESCRIPTION OF THE DRAWINGS

At least one method and system for generating a representation symbol as an identification challenge will be described, by way of example in the detailed description below with particular reference to the accompanying drawings in which like numerals refer to like elements, and:

FIG. 1 illustrates a high level block diagram of a system for generating a symbol identification challenge in accordance with at least one embodiment;

FIG. 2 is a high level flow diagram according to a method of generating a symbol identification challenge in accordance with at least one embodiment;

FIG. 3 illustrates the application of foreground and background properties to a first (base) symbol and a second (noise) symbol and the transition between the foreground and background properties of each image in accordance with at least one embodiment;

FIG. 4 is a refined flow diagram of the application of visual properties as indicated in FIG. 2 in accordance with at least one embodiment;

FIG. 5 illustrates the combining of the transitions for the first (base) symbol and the second (noise) symbol as a simple cycle in accordance with at least one embodiment;

FIG. 6 is a refined flow diagram of the application of a pixel grid to initialize the first and second symbols and define common pixels in accordance with at least one embodiment;

FIG. 7 illustrates the application of a pixel grid to the first and second symbols and an exemplary transition from the foreground property to the background property in accordance with at least one embodiment;

FIG. 8 illustrates an enlarged portion of a common pixel set to illustrate a sweep transition from the first (base) symbol to the second (noise) symbol in accordance with at least one embodiment;

FIG. 9 illustrates an enlarged portion of a common pixel set to illustrate an alternative sweep transition from the first (base) symbol to the second (noise) symbol in accordance with at least one embodiment;

FIG. 10 illustrates the combining of the transitions for the first (base) symbol and the second (noise) symbol as a sweep transition cycle in accordance with at least one embodiment;

FIG. 11 illustrates the combining of the transitions for the first (base) symbol and the second (noise) symbol as a conical transition cycle in accordance with at least one embodiment;

FIG. 12 illustrates the combining of the transitions for the first (base) symbol and the second (noise) symbol as a plasma transition cycle in accordance with at least one embodiment;

FIG. 13 presents a conceptual summary of the generated symbol identification challenge views as being human only perceptible; and

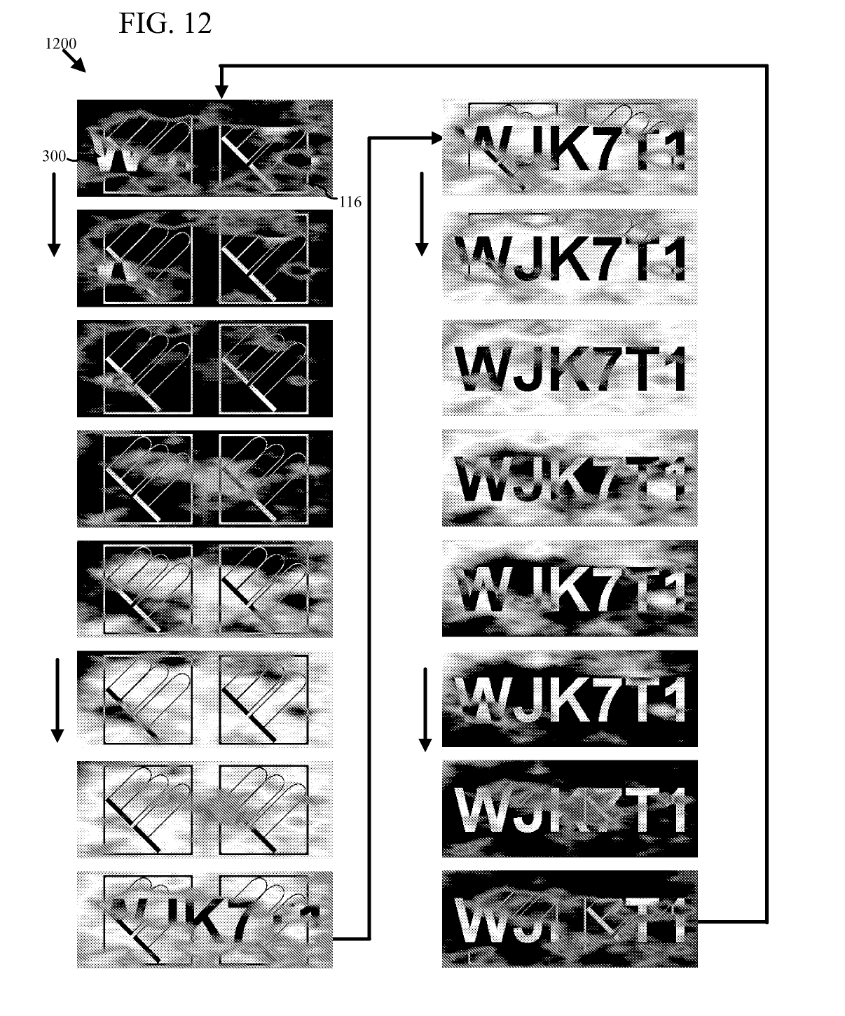

FIG. 12 is a block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific system or method for generating a representation of a symbol as an identification challenge. Thus although the instrumentalities described herein are for the convenience of explanation shown and described with respect to exemplary embodiments, it will be understood and appreciated that the principles herein may be applied equally in other types of systems and methods involving the generation of a representation of a symbol as an identification challenge.

The present disclosure advances the art by providing, in at least one embodiment, a method for generating a representation of a symbol as an identification challenge. Moreover, in at least on embodiment a method and system are provided which provide an advantageous CAPTCHA representation which combines multiple images in such a way that even if each symbol is determined there is no clear indication of which symbols are true data and which symbols are noise data. Further still, in at least one embodiment, the method and system does not include a key view, e.g. a substantially clear view of all elements forming the sensitive data.

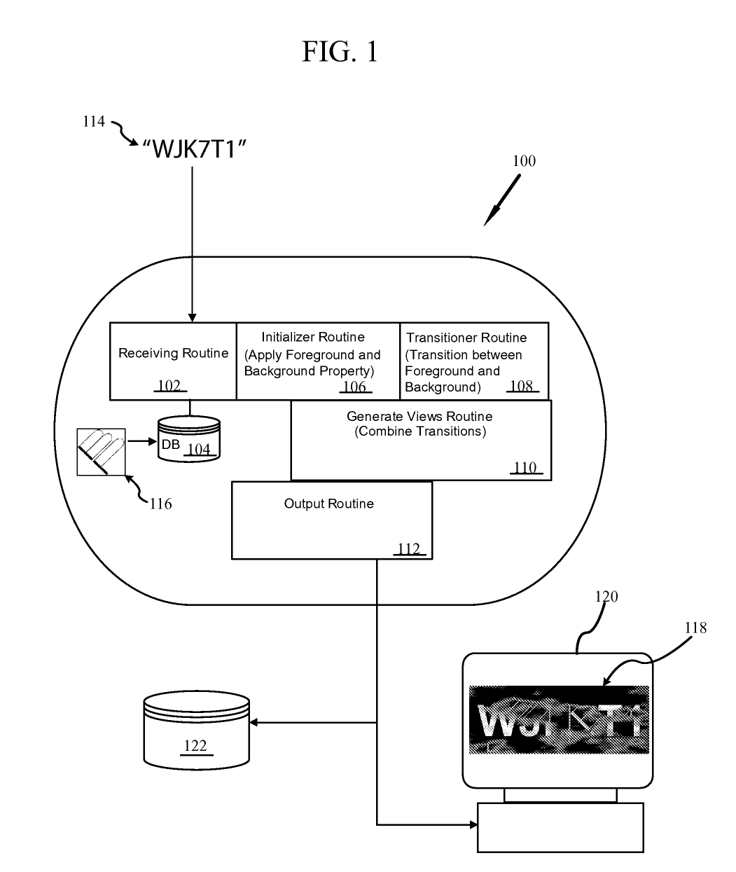

FIG. 1 is a high level block diagram of a system for generating a symbol identification challenge (“SGSIC”) 100 that poses an identification challenge according to at least one embodiment. SGSIC 100 is shown to include a receiver, a database, an initializer, a transitioner, a view generator and an outputter. More specifically with respect to FIG. 1, SGSIC 100 is conceptually illustrated in the context of an embodiment for computer program architecture. SGSIC 100 may be employed on a computer having typical components such as a processor, memory, storage devices and input and output devices. During operation, the SGSIC 100 may be maintained in active memory for enhanced speed and efficiency. In addition, SGSIC 100 may also be operated within a computer network and may utilize distributed resources.

As shown in FIG. 1, SGSIC 100 includes a receiving routine 102, a database 104, an initializer routine 106, a transitioner routine 108, a generate views routine 110 and an output routine 112. As is further set forth and described below, the elements of SGSIC 100 may be summarized for at least one embodiment as follows.

The receiving routine 102 is operable to receive at least one first symbol 114. In at least one embodiment the first symbol 114 is provided by a user of SGSIC 100. A user of SGSIC 100 may be a human operator. A user of SGSIC 100 may also be another system, such as for example a system operating to provide passwords, login IDs or other information. The receiving routine 102 is also operable to receive at least one second symbol 116 from a database 104.

In at lest one embodiment, the second symbol 116 is understood and appreciated to be noise symbol 116, as is further characterized and descried below. Further, the first symbol 114 is understood and appreciated to be a base symbol 114. Moreover, as used herein the terms base symbol and noise symbol are understood and appreciated to be synonymous with “first symbol” and “second symbol” respectively. Further still, although in at least one embodiment, the second symbol, e.g., noise symbol 116 is provided by a database, in at least one alternative embodiment the noise symbol 116 is provided by the user. For example, the first symbol provided by a user is accepted by SGSIC 100 to be the base symbol and subsequent first symbols provided by the user are accepted by the SGSIC 100 to be one or more noise symbols 116.

Indeed, for an embodiment wherein the user of SGSIC 100 provides multiple symbols, the distinction between a base symbol and a noise symbol may be superfluous as SGSIC 100 will process the provided symbols (whether conveying sensitive information or noise information), collectively to provide the resulting identification challenge. Moreover, SGSIC 100 does not act to treat a base image in a way that is substantially different from a noise image.

Although the following examples make use of a single base symbol 114 and a single noise symbol 116, it is understood and appreciated that whether provided by the user or the database, in varying embodiments SGSIC 100 will incorporate a plurality of noise symbols 116 with the base symbol 114.

In the accompanying figures for purposes of example, the first symbol 114 is shown to be “WJK7T1” and the second symbol 116 is shown to be the graphic icon for “Bot-Proof.” In varying embodiments, the base symbol 114 and noise symbol 116 may be provided as an alphanumeric character, a non-alphanumeric character such as an icon, arrow, logo, figure and or combinations thereof. In at least one embodiment the base symbol and noise symbol may be provided as or with symbol identification, such as for example ASCII representation code. Alternative forms of symbol data may include, but are not limited to BMP (Windows Bitmap), GIF (CompuServe Graphical Image Format), PNG (Portable Network Graphics), SVG (Scalable vector Graphics), VRML (Virtual Reality Markup Language), WMF (Windows MetaFile ), AVI (Audio Visual Interleave), MOV (QuickTime movie), SWF (Shockwave Flash), DirectX, OpenGL, Java, Windows®, MacOS®, Linux, PDF (Portable Document Format), JPEG (Joint Photographic Experts Group, MPEG (Moving Picture Expert Group) or the like.

As is further discussed below and illustrated in the accompanying figures, SGSIC 100 operates to combine the base symbol 114 and one or more noise symbols 116 into a composite view 118. As such, in at least one embodiment the noise symbol 116 is sized or otherwise scaled to appropriately match to about the size of the base symbol 114. In at least one alternative embodiment, such as when the noise symbol 116 is small, the noise image element 114 may be repeated to provide a composite noise symbol as is shown in the accompanying figures. For purposes of discussion, as used herein the term “noise symbol” or “second symbol” is understood and appreciated to apply to all symbols whether scaled, stretched, scrunched, repeated or otherwise modified and/or adjusted to be of an appropriate size to about match the base symbol 114.

The initializer routine 106 is operable in at least one embodiment to apply a foreground property and a background property to each received base symbol 114 and noise symbol 116. Moreover, the initializer routine 106 applies a first visual property and a second visual property to the base symbol 114 and a third image property and a fourth image property to the noise symbol 116.

In at least one embodiment these properties are contrast values. It is further understood and appreciated that contrast values permit the difference between things, e.g. the foreground and background, to be distinguished and appreciated. In many instances the contrast values are applied to one or more colors. In at least one alternative embodiment these properties are colors. Further still, in at least one embodiment the visual properties applied to the base symbol 114 are the same visual properties applied to the noise symbol 116. In yet still another alternative embodiment the visual properties applied to the base symbol 114 are inverted when applied to the noise symbol 116.

The transition routine 108 is operable to transition each symbol between its foreground property and its background property. The generate views routine 110 is operable to generate a plurality of views, e.g., composite view 118, by combining the respective transitions of each symbol. The output routine 112 is operable to output the generated views 118, such as in one embodiment to a display 120, and in at least one alternative embodiment to a database 122.

With respect to FIG. 1, it is understood and appreciated that the elements, e.g., receiver (receiving routine 102), the database 104, the initializer (initializer routine 106), the transitioner (transition routine 108), the view generator (generate views routine 110) and the outputter (output routine 110) are in one embodiment located within a single device, such as for example a computer. In at least one alternative embodiment, these elements may be distributed over a plurality of interconnected devices. Further, although each of these elements has been shown conceptually as an element, it is understood and appreciated that in varying embodiments, each element may be further subdivided and/or integrated with one or more other elements.

Moreover, in at least one embodiment, SGSIC 100 comprises a receiver 102 structured and arranged with an input device for permitting at least one first symbol 114 to be received. SGSIC 100 further includes a database providing at least one second symbol 116, should the second symbol not otherwise be provided by the user. SGSIC 100 has an initializer 106 structured and arranged to initialize each first and second symbol by applying to each symbol a foreground property and a background property. Further, a transitioner 108 is structured and arranged to transition each symbol between the foreground property and the background property. The composite views 118 are provided by a view generator 110 structured and arranged to generate a plurality of views by combining the transitions of the symbols.

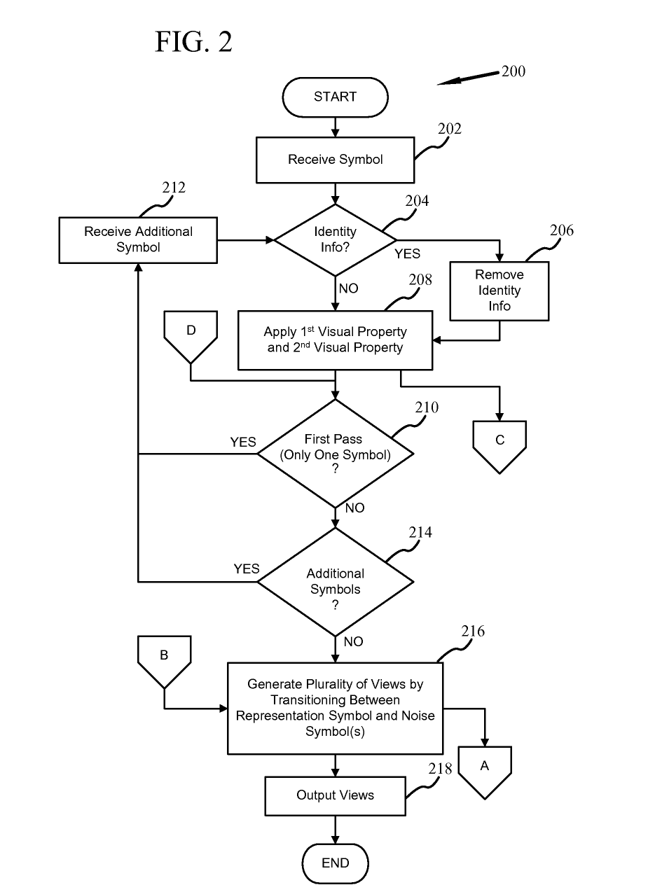

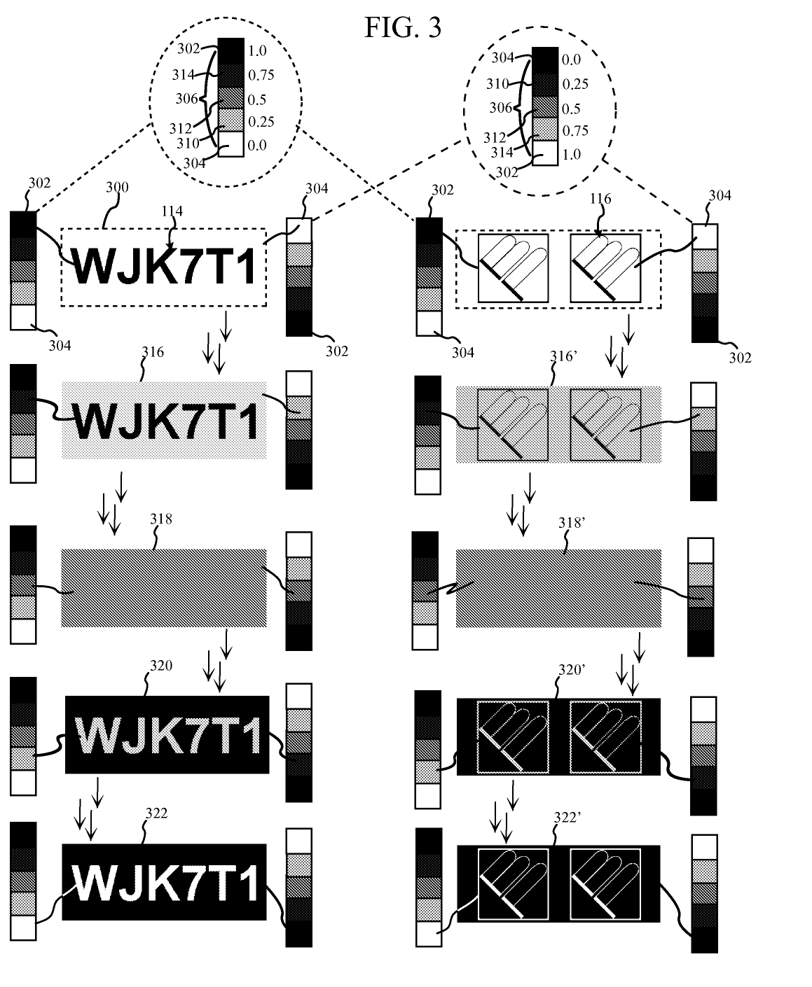

FIG. 2 in connection with FIGS. 3-13 provides a high level flow diagram with conceptual illustrations depicting a method 200 for generating a symbol identification challenge in accordance with at least one embodiment. It will be appreciated that the described method need not be performed in the order in which it is herein described, but that this description is merely exemplary of one method of generating a symbol identification challenge.

To summarize, in at least one embodiment, the method 200 includes receiving a plurality of symbols, e.g., the base symbol 114 and noise symbol 116. A first visual property and a second visual property are then applied to each received symbol. Each received symbol is then transformed by transitioning the first visual property to the second visual property and the second visual property to the first visual property. A plurality of views are then generated by transitioning between the symbols.

Moreover, in at least one embodiment, the method 200 commences when a first symbol, e.g., a base symbol 114, is received, block 202. As noted above, different embodiments permit a variety of formats for the symbol. If the symbol is provided as symbol data, the appropriate symbol associated with the data is generated. The symbol data, if provided as or with the base and noise symbols, is then removed, decision 204 and block 206. In at least one alternative embodiment this symbol data information is stored for later use and/or reference.

A first visual property and a second visual property is then applied to the received symbol, block 208. In at least one embodiment, the first visual property is a foreground property and the second visual property is a background property. Further still, in at least one embodiment the visual properties are that of color. In an alternative embodiment, the visual properties are that of contrast. In yet an alternative embodiment, the visual properties are that of luminance. In yet still another embodiment, the visual properties are that of transparency. Still further, in yet another embodiment the foreground and background properties are varying combinations of color, luminance, contrast and transparency.

It is understood and appreciated that the symbol may be provided in a condition where it has from the outset a foreground property, e.g., foreground color, and a background property, e.g., background color. In at least one embodiment, these foreground and background properties may be utilized directly. In at least one alternative embodiment the method 200 may query the user to accept and utilize the initial foreground and background properties as provided or perform a substitution.

For purposes of discussion, when the first symbol received is a base symbol 114, in at least one embodiment, application of the first and second visual properties results in the generation of an initial representation symbol. Fundamentally, the initial representation symbol is in at least one embodiment simply the base symbol 114 with first and second visual properties applied, it is simply referenced as an initial representation symbol to help understand the developing process. Where the base symbol 114 is supplied with an acceptable first and second visual property, the distinction of initial representation symbol and base symbol 114 may be effectively moot.

FIG. 3 provides a conceptual illustration of the base symbol 114 initialized as an initial representation symbol 300, having a foreground color 302 (black) and a background color 304 (white). It is understood and appreciated that luminance values can also provide the visualization of black and white, however for purposes of illustration and discussion, the colors of black and white, and the range therebetween have been adopted. It is also understood and appreciated, that colors other than black and white may be employed.

With respect to FIG. 3, it is also understood and appreciated that the foreground color 302 and background color 304 define a range 306. For an embodiment wherein the foreground and background property is that of illumination, the range is a luminance range. For an embodiment employing transparency, generally the foreground and background also have at least a color or luminance value in addition to a transparency value ranging from about entirely transparent to about entirely opaque.

Returning to FIG. 2, as the generated symbol identification challenge involves transitioning between symbols, the method 200 checks at decision 210 to see if it is in the first pass, e.g., only one symbol has been received. In response to a “yes” the method 200 branches to receive an additional symbol, block 212. In at least one embodiment, the user is promoted to supply the additional symbol, e.g., a noise symbol 116. In at least one alternative embodiment, the additional symbol, e.g., a noise symbol 116, is supplied by a database. Typically a convention is adopted so that the user may specify which symbol is intended as the base symbol, e.g., the very first symbol that the user provides to SGSIC 100.

For the additional symbol received, the method 200 again checks for identity information, decision 204, and applies a first visual property and a second visual property to the received symbol, block 208. As the method 200 is now in the second pass, an automatic return to receive an additional symbol is not imposed, decision 210. Rather the method now queries to see if additional symbols are desired, decision 214. In response to a “yes” the method returns as above to receive the additional symbols, remove their identify info if provided and apply first and second visual properties, block 212, decision 204, block 208.

It is understood that the first and second visual properties are in one instance the same for all received symbols. In yet an alternative embodiment it is understood and appreciated that for at least two received symbols the first and second visual properties are different. For discussion purposes, and as shown in the flow diagram of FIG. 2, it may be helpful to uniquely identify the visual properties applied to each received symbol.

More specifically, in at least one embodiment, the type of property applied to the received base symbol 114 and the type of property applied to the received noise symbol 116 are of the same variety. Further still the applied properties may be substantially the same. For example, in one embodiment the first property of the first symbol (base symbol 114) is a foreground property and the first property of the second symbol (noise symbol 116) is about the same foreground property. The second property of the first symbol (base symbol 114) is a background property and the second property of the second symbol (noise symbol 116) is about the same background property.

In other words, in at least one embodiment the first foreground color is about equal to the second foreground color and the first background color is about equal to the second background color. In an alternative embodiment, this relationship is inverted. For example, again for an embodiment utilizing the property of color, in at least one embodiment the first foreground is about equal to the second background and the first background is about equal to the second foreground.

With the initial representation symbol and initial noise symbol the method 200 advances to generating a plurality of views by transitioning between the representation symbol and the noise symbol(s), block 220. The plurality of generated views are then output, block 218. In at least one embodiment the views are output to a display. In at least one alternative embodiment the views are output to a storage device, such as for example a hard drive.

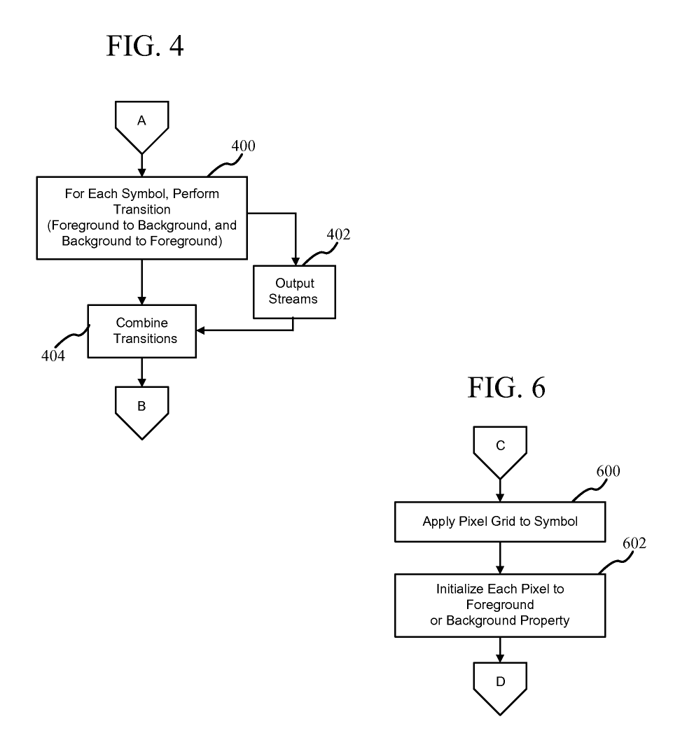

FIG. 4 provides a refined flow diagram for the action of generating the plurality of views. Specifically for each symbol (e.g., the base symbol and each noise symbol) the method 200 acts to transition the foreground to the background, block 400. In at least one embodiment the transition from foreground to background is a cyclical process, though in varying embodiments the cycle may or may not have the same period from one cycle to the next. In at least one alternative embodiment the transition from foreground to background has no defined cycle such that each transition of foreground to background occurs in a different and unpredictable manner.

The transition of each symbol may in at least one embodiment be described as a stream of data, which may be stored for later processing or contemporaneously combined with the streams of other symbols. As is understood by those skilled in the arts, a stream may be advantageous in processing for only portions of the stream are required at any given time. Moreover, the stream may be maintained in storage memory that is read periodically to obtain the next elements of the stream for subsequent processing. Indeed in at least one embodiment, the transition of each symbol is characterized and stored as a stream, optional block 402. It is also understood and appreciated that the transition of the base symbol and the transition of the noise symbol are in at least one embodiment performed about contemporaneously.

The views are provided by combining the transitions, block 402. Of course this combination may be performed substantially contemporaneously with the transition performed in block 400, or at some later time as permitted by stored streams. A further understanding of combining of the transitions is presented in FIG. 3.

As with the initial representation symbol 300, the noise symbol 116 is initialized and shown to have about the same foreground color 302 and about the same background color 304, and about the same range 306 therebetween. The range 306, showing five different color values is by way of example and not limitation. Indeed it is understood and appreciated that in varying embodiments ranges of greater or fewer values may be enjoyed.

With respect to the exemplary range 106, if the initial black color 302 is taken to be represented by the value of “1.0” and the initial white color 302 is taken to be the value of “0.0” then the intervening colors 310, 312 and 314 are respectively represented by the values at 0.25 increments therebetween, i.e., “0.25”—310, “0.5”—312 and “0.75”—314.

Both the representation symbol 300 and the noise symbol 116 are shown to transition between the respective foreground color 302 and background color 304. More specifically, representation symbol 316 results from incrementing the foreground towards the background one step while incrementing the background towards the foreground one step. Likewise, noise symbol 316′ results from incrementing the foreground towards the background one step while incrementing the background towards the foreground one step.

Incrementing the foreground and background values yet again for the representation symbol results in representation symbol 318, and for the noise symbol results in noise symbol 318′. Incrementing the foreground and background values yet again for the representation symbol results in representation symbol 320, and for the noise symbol results in noise symbol 320′. Finally, incrementing the foreground and background values yet again for the representation symbol results in representation symbol 322, and for the noise symbol results in noise symbol 322′. As shown, in representation symbol 322 and noise symbol 322′ the foreground color is now white 304 and the background color is now black 302.

With respect to FIG. 3, and more specifically representation symbol 318 and noise symbol 318′, it is understood and appreciated that for each symbol the background color (or property) and the foreground color (or property) is about equal. Moreover, as each symbol is transformed, the transition of foreground to background passes through a midpoint wherein the foreground and background are about equal. In at least one embodiment, a cycle of transition for each symbol is measured from midpoint to midpoint.

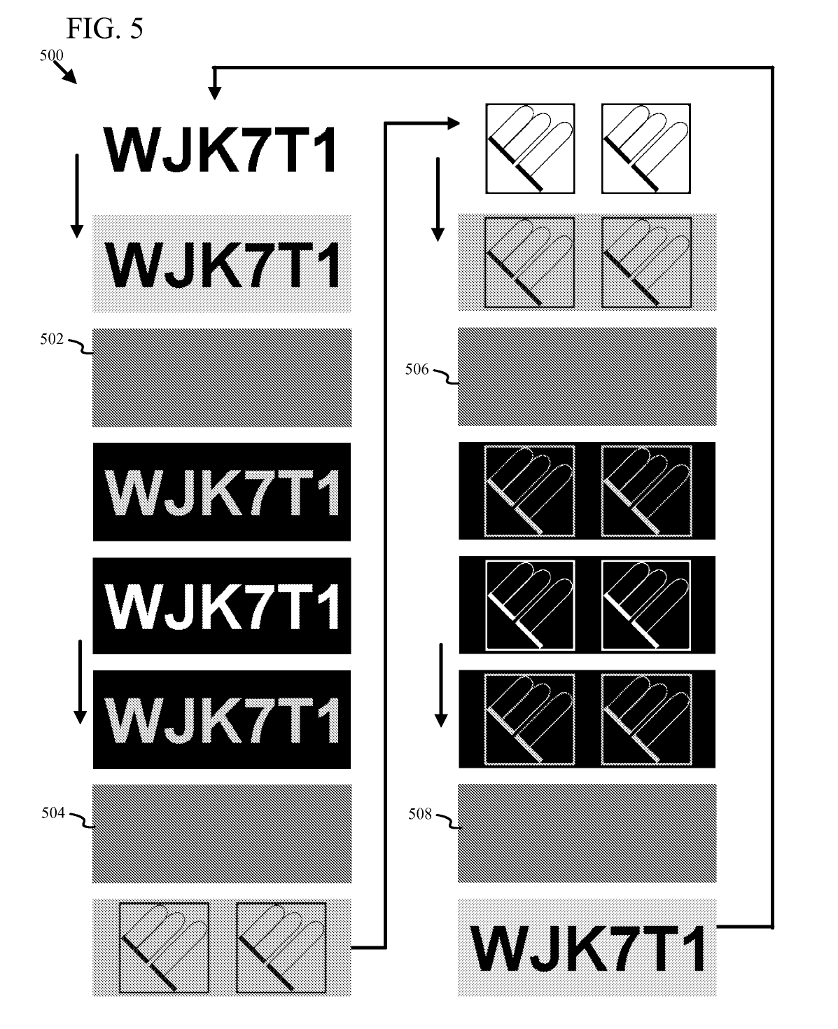

FIG. 5 illustrates at least one embodiment for the combined transitions of the representation symbol 300 and the noise symbol 116 as a simple cycle 500. The first midpoint 502 occurs during the first transition between background and foreground for the representation symbol 300, and as such the transition continues without interruption. At the second midpoint 504, the transition shifts from the representation symbol to the noise symbol 116 which continues to transition at about the same increments. At the third midpoint 506 the noise symbol 116 is still in the first cycle between background and foreground and therefore the transition continues without interruption. However, at the fourth midpoint 508, the transition shifts from the noise symbol 116 back to the representation symbol 300, and the entire transition process continues again.

It is of course understood and appreciated that key view may exist for both the representation symbol 300 and the noise symbol 116. However, there are only two symbols shown in this transition. In at least one embodiment there is a plurality of symbols, and it is of course understood and appreciated that the identity of the base symbol, now conveyed as the representation symbol 300, and the noise symbol 116 are not otherwise identified. Moreover, noise symbols are generally those that a human user would quickly recognize and understand to be irrelevant. As such, even though an automated agent might be able to recognize each symbol, the automated agent can not determine which symbol is the true base symbol.

To briefly summarize, in at least one embodiment, method 200 includes receiving a base symbol 114 and generating a representation symbol 300 by applying a first foreground property and a first background property to the base symbol. A noise symbol 116 is selected, if not otherwise received from the user, the noise symbol likewise having a second foreground property and a second background property. The representation symbol 300 is transformed by transitioning the first foreground property to the first background property and the first background property to the first foreground property. The noise symbol 116 is transformed by transitioning the second foreground property to the second background property and the second background property to the second foreground property. A plurality of views 118 is then generated by combining the transition of the representation symbol 300 with the transition of the noise symbol 116.

Application of the visual properties to the base symbol 114 and the one or more noise symbols 116 may be achieved in a variety of ways as appropriate for varying implementations of SGSIC 100 and/or method 200. In at least one embodiment the elements comprising the base symbol 114, e.g. the “WJK7T1” and the noise symbol 116, e.g. the stylized “BP” are processed a processed as vectors upon a background area. The elements of the vectors and the background area are each individually addressable and therefore each may be assigned a different visual property, e.g. foreground color and background color.

In at least one alternative embodiment, the representation symbol 300 as generated from the base symbol 114 and the one or more noise symbols 116 are pixelated. In FIG. 2, block 208, which indicate the application of the first and second visual properties to the received symbol, has off page references leading to FIG. 6 which further illustrates the flow diagram for such a pixilation in accordance with at least one embodiment.

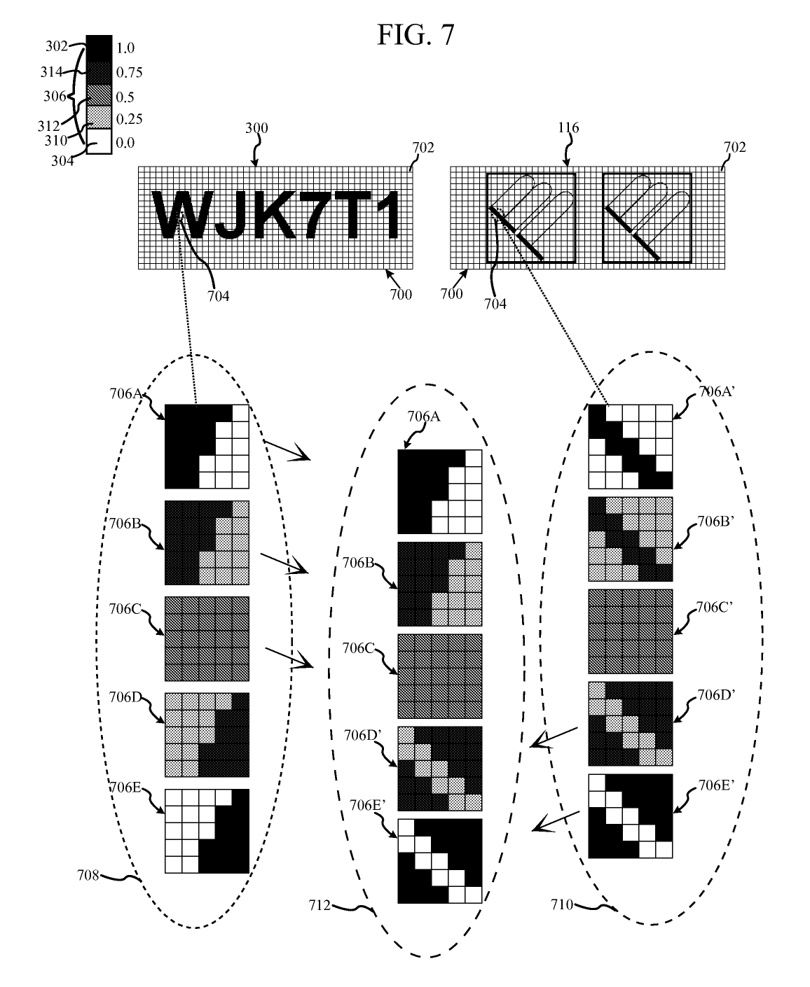

FIG. 6 may be further understood and appreciated in connection with FIG. 7. A pixel grid 700 is applied to the symbol, block 600. As the same pixel grid 700 is imposed upon each symbol, the grid 700 defines common pixel locations, of which pixel 702 located at the top right is exemplary, for the representation symbol 300 and the noise symbol 116. It is understood and appreciated that multiple instantiations of pixel grid 700 may be used, however as each grid is identical each may be considered to be the same grid 700. Further, pixel grid 700 is illustrated as being eighteen (18) pixels by forty-seven (47) pixels for ease of illustration, and not to suggest limitation. Moreover, pixel grid 700 is not shown to scale.

With the pixel grid 700 imposed and the pixel locations so defined, each pixel is initialized to either a foreground property or a background property. To restate the above discussion, the initial foreground and background properties are paired to define the extremes of a range of the visual property. In at least one embodiment the visual property is color. In an alternative embodiment the visual property is contrast. In yet another alternative embodiment the visual property is luminance. Further still in another embodiment, the visual properties are varying combinations of color, luminance, contrast and transparency.

For ease of discussion and illustration, the visual property of color and the range 306 as between black 302 and white 304 is again repeated from FIG. 3. Dotted circle 704 is intended to identify the same exemplary five by five common pixels set 706 for the base symbol 114 (now the representation symbol 300) and the noise symbol 116.

Set 706A conceptually illustrates a portion of the “W” from the representation symbol 300 and 706A′ conceptually illustrates a portion of the “B” from the noise symbol 116. Sets 706B, 706B′, 706C, 706C′, 706D, 706D′ and 706E, 706E′ each respectively show the exemplary 0.25 incremental change of each pixel to transition from the initial condition shown in 706A, 706A′ to the inverted condition show in 706E, 706E′. Considering 706A-706E as a first stream 708 and 706A′-796E′ as a second stream 710, the transition from the first stream 708 to the second stream 710 may also be further appreciated with respect to the composite stream 712.

Moreover, sets 706C and 706C′ both show all pixels to be of substantially the same color. In accordance with at least one embodiment, the switch from the first stream 708 to the second stream 710 is advantageously performed at the midpoint in pixel transition as illustrated in sets 706C and 706C′. More specifically, in providing the plurality of views by combining the transitions, sets 706A-706C are taken from the first stream 708.

As the midpoint has been reached in set 706C of the first stream 708, the method 200 switches to draw sets 706D′ and 706E′ in ordered succession from second stream 710. The composite stream 712 thus presents an ordered progression from the initial portion of the “W” of the representation symbol 300 to the inverted portion of the “B” of the noise symbol 116.

To summarize, in at least one embodiment, the method 200 includes receiving a base symbol 114. A representation symbol 300 is generated by imposing a pixel grid 700 upon the base symbol 114. Each pixel receives an initial value as foreground or background. A noise symbol 116 is selected if not otherwise provided. The pixel grid 700 is imposed upon the noise symbol, and each pixel receives an initial value as foreground or background. A first stream 708 is generated by transitioning each pixel in the representation symbol 300 through a range defined by the foreground and the background. A second stream is generated by transitioning each pixel in the noise symbol 114 through a range defined by the foreground and the background. A plurality of views 118 is generated by combining the first stream 708 and the second stream 710.

The transition of the pixels in the above description is shown and described to be in an ordered progression through the defined range 306. Although the ordered progression of transition through the range is advantageous for many embodiments, in at least one alternative embodiment the transition of the pixels is not directly incremental. More specifically, in at least one embodiment the transition of the visual property within range 306 may be patterned, random, pseudo-random, or even chaotic within the range. For example, in at least one embodiment an indirect transition involving hopping or back and forth oscillation provides a flicker effect to each symbol which may be desired in certain embodiments.

In at least one embodiment, the switch from one symbol or stream to another symbol or stream occurs in a recurring fashion at every midpoint. In other words at every one, two, three or other interval of midpoints a switch between symbols or streams occurs. In yet another embodiment the switch from one symbol or stream to another symbol or stream will occur at a midpoint in accordance with a random, pseudo-random, or other non-linear function.

With respect to the examples shown in FIGS. 3, 5 and 7, it is clear that transforming each symbol is performed by contemporaneously transitioning the visual property (e.g. color) of all pixels incrementally. In at least one alternative embodiment the transitioning of the visual property is performed incrementally in accordance with a pattern. With the above discussion of at least one embodiment employing pixilation, further embodiments for incremental transition of pixels are presented in FIGS. 7-11.

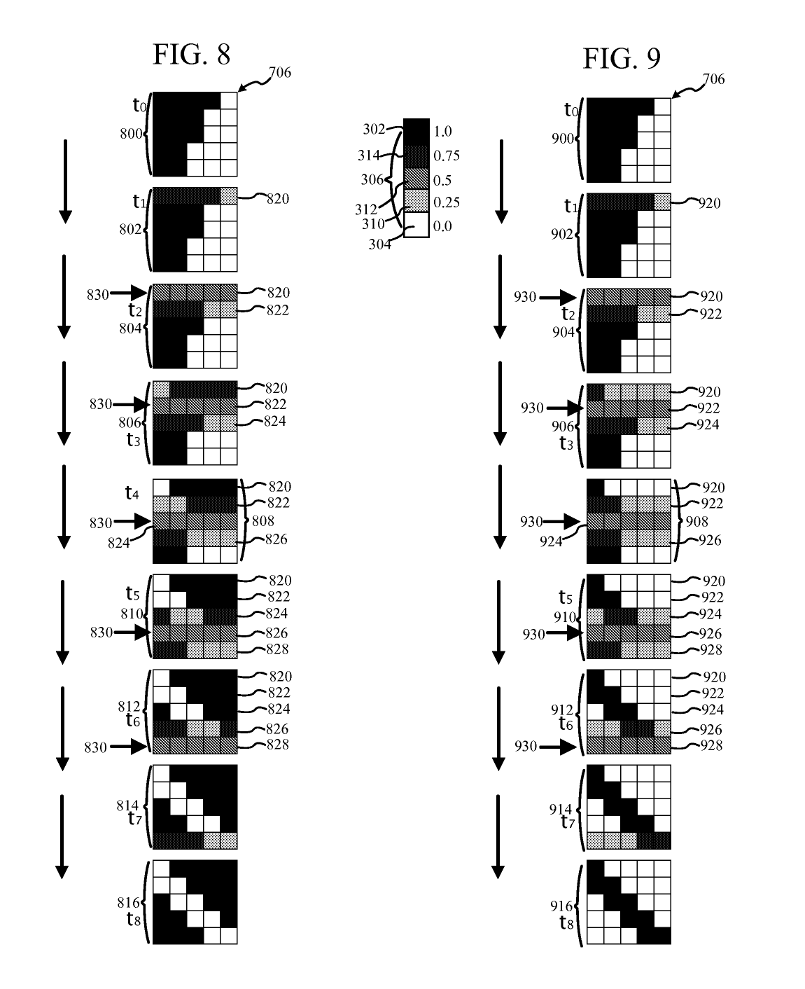

FIGS. 8 and 9 each conceptually illustrate a sweep transition as applied to the five by five common pixel set 706 shown in FIG. 7. For purposes of this example, the transition states are set to occur at increments of time, t₀-t₈. State 800 is the initial state, t₀. At t₁ in state 802 the pixels of the top row 820 are adjusted by one value from their prior state. Moreover the top right most pixel is incremented from a color value of “0” 304 to a color value of “0.25” 310. The remaining pixels of the top row are adjusted from a color value of ‘1” 302 to a color value of “0.75” 314.

At t₂ in state 804, the pixels of the second row 822 and the pixels of the first row 820 adjusted by one value from their prior state. In so doing, the pixels of the top row 820 have reached their midpoint and the top row 820 is now considered a transition row 830.

At t₃ in state 806, the pixels of the third row 824 and the pixels of the second row 822 and first row 820 are adjusted by one value from their prior state. Row 822 is now a transition row 830 and first row 820 increments to appear as shown in set 706D′ of FIG. 7.

At t₄ in state 808, the pixels of the fourth row 826, the third row 824, the second row 822 and the first row 820 are adjusted by one value from their prior state. Row 824 is now a transition row 830. First row 820 increments again to now appear as the top row shown in set 706E′ of FIG. 7. Similarly, second row 822 increments to appear as the second row from the top in set 706D′ of FIG. 7.

At t₅ in state 810, the pixels of the fifth row 828, the fourth row 826 and the third row 824 and the second row 822 are adjusted by one value from their prior state. The first row 802 reaches its converted state at t₄. Row 826 is now a transition row 830. Second row 822 increments again to now appear as the second row shown in set 706E′ of FIG. 7. Similarly, third row 824 increments to appear as the third row from the top in set 706D′ of FIG. 7.

At t₆ in state 812, the pixels of the fifth row 828, the fourth row 826 and the third row 824 are adjusted by one value from their prior state. The first row 802 reaches its converted state at t₄ and the second row 804 reached its converted state at t₅. Row 828 is now a transition row 830. Third row 824 increments again to now appear as the third row shown in set 706E′ of FIG. 7. Similarly, forth row 826 increments to appear as the fourth row from the top in set 706D′ of FIG. 7.

This sweeping progression is continued at state 814 for t₇ and state 816 for t₈ wherein the exemplary portion of the transition is complete, the initial portion of the representation symbol 300 (e.g., black on white) having transitioned to inverted portion of the noise symbol 116 (e.g., white on black).

FIG. 9 presents a similar example illustration the transition of the initial portion of the representation symbol 300 (e.g., black on white) to the initial portion of the noise symbol 116 (e.g., black on white). Again transition states are set to occur at increments of time, t₀-t₈. State 900 is the initial state, t₀. At t₁ in state 902 the pixels of the top row 920 are adjusted by one value from their prior state. Moreover the top right most pixel is incremented from a color value of “0” 304 to a color value of “0.25” 310. The remaining pixels of the top row are adjusted from a color value of ‘1” 302 to a color value of “0.75” 314.

At t₂ in state 904, the pixels of the second row 922 and the pixels of the first row 920 adjusted by one value from their prior state. In so doing, the pixels of the top row 920 have reached their midpoint and the top row 920 is now considered a transition row 930. Transition row 930 is equivalent to transition row 830 as shown in FIG. 8

At t₃ in state 906, the pixels of the third row 924, the second row 922 and first row 920 are adjusted by one value from their prior state. Row 922 is now a transition row 930 and first row 920 increments as shown in set 706B′ of FIG. 7.

At t₄ in state 908, the pixels of the fourth row 926, the third row 924, the second row 922 and the first row 920 are adjusted by one value from their prior state. Row 924 is now a transition row 930. First row 920 increments again to now appear as the top row shown in set 706A′ of FIG. 7. Similarly, second row 922 increments to appear as the second row from the top in set 706B′ of FIG. 7.

At t₅ in state 910, the pixels of the fifth row 928, the fourth row 926, the third row 924, the second row 922 and the first row 920 are adjusted by one value from their prior state. Row 926 is now a transition row 930. Second row 922 increments again to now appear as the second row shown in set 706A′ of FIG. 7. Similarly, third row 924 increments to appear as the third row from the top in set 706B′ of FIG. 7.

At t₅ in state 910, the pixels of the fifth row 928, the fourth row 926 and the third row 924 and the second row 922 are adjusted by one value from their prior state. The first row 902 reaches its converted state at t₄. Row 926 is now a transition row 930. Second row 922 increments again to now appear as the second row shown in set 706A′ of FIG. 7. Similarly, third row 924 increments to appear as the third row from the top in set 706B′ of FIG. 7.

At t₆ in state 912, the pixels of the fifth row 928, the fourth row 926 and the third row 924 are adjusted by one value from their prior state. The first row 902 reaches its converted state at t₄ and the second row 904 reached its converted state at t₅. Row 928 is now a transition row 930. Third row 924 increments again to now appear as the third row shown in set 906A′ of FIG. 7. Similarly, forth row 926 increments to appear as the fourth row from the top in set 706B′ of FIG. 7.

This sweeping progression is continued at state 914 for t₇ and state 916 for t₈ wherein the exemplary portion of the transition is complete, the initial portion of the representation symbol 300 (e.g., black on white) having transitioned to the initial portion of the noise symbol 116 (e.g., black on white). In one embodiment, the intervals of time defining are uniform. In yet another alternative embodiment the intervals of time defining are not all uniform, moreover at least one interval of time is greater than or less than at least one other interval of time.

With respect to the above description, several advantageous principles may be appreciated for SGSIC 100 and method 200 which exist individually or in collective subsets in varying embodiments. These principles include, but are not limited to:

First, each element, i.e. pixel, of each symbol transitions within a range. In at least one embodiment this transition is directed by a function adapted to return values within the range.

Second, the transformation of pixels of each symbol may be transitioned contemporaneously as a whole.

Third, the transformation of the pixels of each symbol may be transitioned incrementally in a pattern. The determination of which pixels to transition (in accordance with a pattern) is in at least one embodiment determined by a function adapted to return values within a range. In at least one embodiment the range is the defined grid of common pixels and the values correspond to one or more subsets of pixels within the range.

Fourth, the midpoint within the visual property range, e.g., color range 306, provides a natural point at which to switch from one symbol or stream to another symbol or stream.

In at least one embodiment the function adapted to control the pattern for selecting pixels for incremental transition is selected from the group of: a sin function applied horizontally, vertically or diagonally across the grid; a conical function applied to the grid; a fractal function applied to the grid; a chaotic function applied to the grid; a random function applied to the grid; a pseudo-random function applied to the grid; a linear function applied to the grid; a non-linear function applied to the grid; and or combinations thereof.

Although the midpoint within the visual property range is an advantageous point for switching between symbols, other points of the visual property range may also be adapted to signal such a switch. Further still, the transitions of the symbols may be combined in such a way as to contemporaneously show the transitions together.

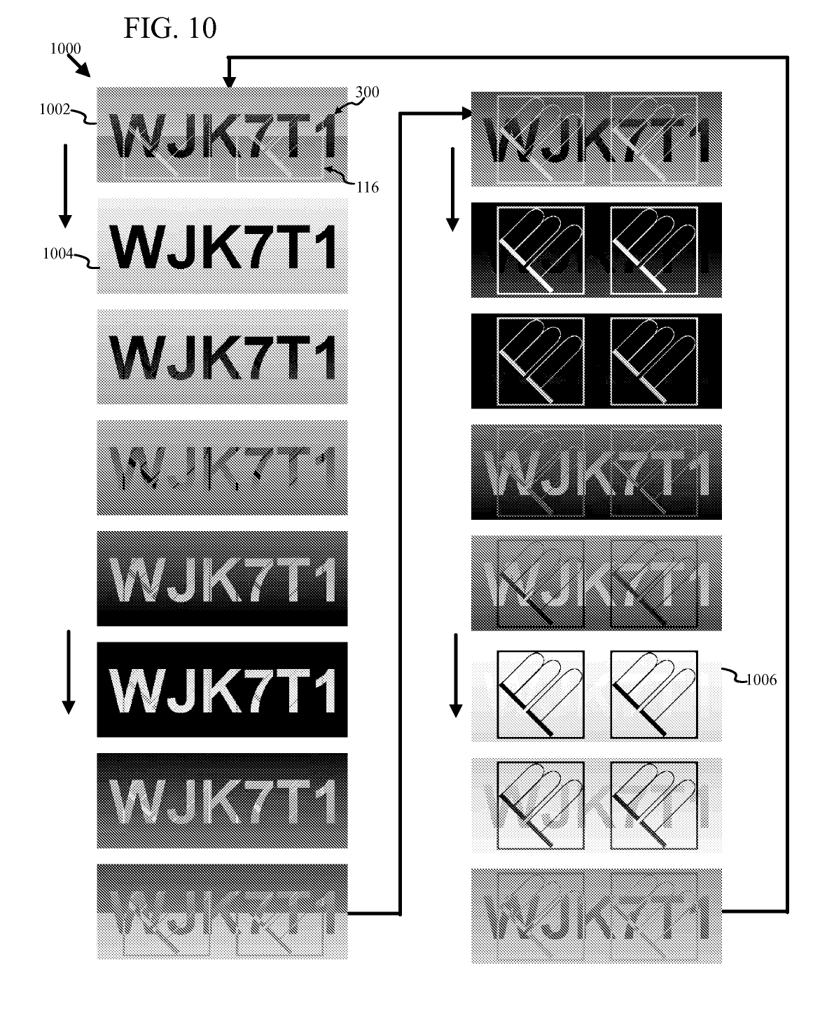

FIGS. 7-9 as discussed above provide enlarged illustrations, specifically common pixel set 706, to illustrate various embodiments for combining the transitions of the representation symbol 300 and noise symbol 116 to provide a plurality of views as a symbol identification challenge. FIGS. 10, 11 and 12 each illustrate more complete views to demonstrate with greater clarity how the transitions of the representation symbol 300 and the noise symbol 116 may be combined to provide different pluralities of views as different symbol identification challenges.

FIG. 10 is generally characterized to be a sweep transformation cycle 1000 similar to that shown in FIG. 9. Moreover, the selection of pixels for transition is systematically determined by a repeating function as applied moving from the top of the composite image to the bottom, each view representing a selected moment in time, generally 28 frames apart from the prior view.

The top left view 1000 has been selected to show the midpoint of transition and switch from the noise symbol 116 to the representation symbol 300. Indeed, in nearly all of the illustrated views, save for view 1002 and 1004 a composite image having elements of both the representation symbol 300 and the noise symbol 116 is clearly present. Although the representation symbol 300 and the noise symbol 116 are not otherwise identified, in at least one embodiment, the views of 1002 and 1004 are discarded so as to eliminate key views.

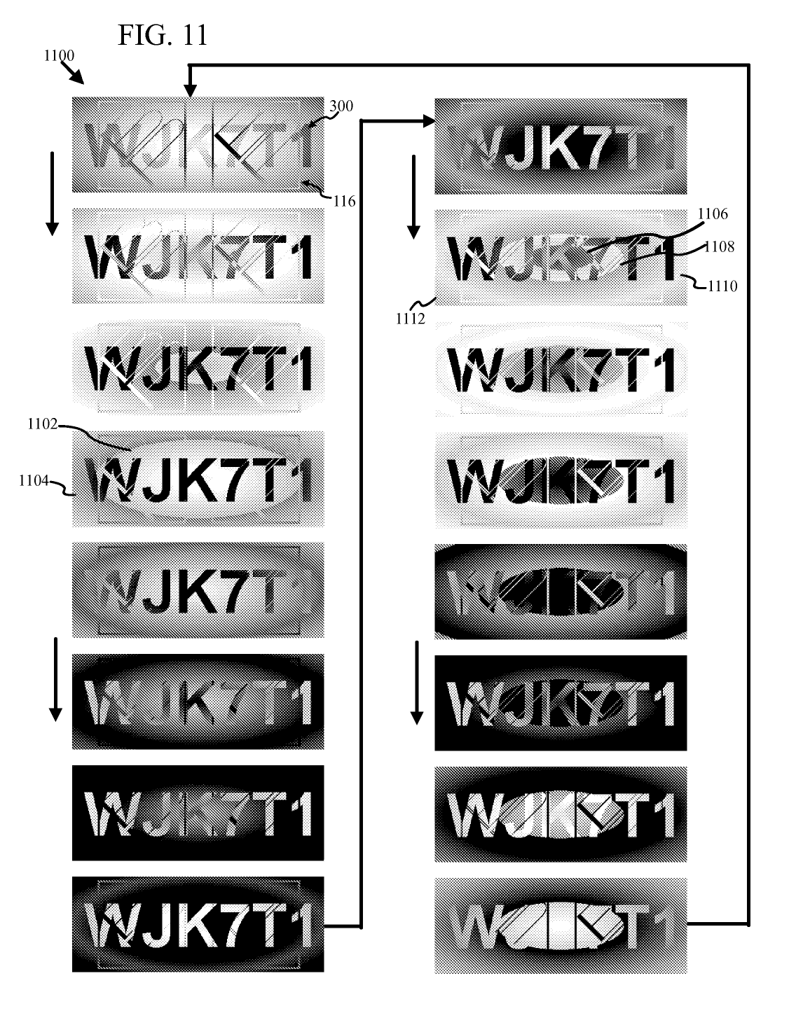

Although perhaps acceptable for some applications, FIG. 10 like FIG. 5 illustrates an embodiment of the symbol identification challenge wherein the combined symbols are each relatively clear. FIGS. 11 and 12 each illustrate embodiments where such individual distinction of the involved symbols is less clear.

Whereas in FIG. 10 the function determining pixel selection was applied from the top to the bottom, in FIG. 11 the function is applied from the outside to the inside as conical waves. As in FIG. 10, each view represents a moment in time, generally 28 frames apart from the prior view. Moreover, the transition between the representative symbol 300 and the noise symbol 116 as shown in FIG. 11 is performed in accordance with a conical transition cycle 1100.

As shown, each view is a composite view showing elements from both the representative symbol 300 and the noise symbol 116. In the varying views, the elements of the symbols overlap, intersect and obscure one another such that in no view is a true key view provided.

As shown there are apparent ovals of varying size, e.g., oval 1102 in view 1104 and ovals 1106, 1108 and 1110 in view 1112. Oval 1106 represents an area of pixels for the noise symbol 116 that are at midpoint.

As shown in FIG. 11, the generated views cycle such that a human user would view a cycling animation of the transition between the representation symbol 300 and the noise symbol 116. As is clearly evident, the complexity of each view is advantageously increased.

FIG. 12 presents a plurality of views by transitioning between the representation symbol and the noise symbol 116 in accordance with a highly advantageous non-linear function. In at least one embodiment, FIG. 12 illustrates a plasma transition cycle 1200. Whereas in FIG. 10 the applied function transitions between the representation symbol 300 and the noise symbol 116 in a top to bottom sweeping function, and in FIG. 11 the applied function transitions between the representation symbol 300 and the noise symbol 116 in an outside to inside conical fashion, the transitions illustrated in FIG. 12 are far more intractable.

As shown, the representation symbol 300 and the noise symbol 116 appear to bleed through one another as the transition occurs. As in FIGS. 9 and 10, each view represents a moment in time, generally 28 frames apart from the prior view. In the varying views, the elements of the symbols overlap, intersect and obscure one another such that in no view is a true key view provided.

For each of the above example embodiments shown in FIGS. 10, 11 and 12 each may be further understood and described with respect to the above discussion of the applied grid to define common pixels as being grids of offsets values used to offset the initial color values of both the representation symbol 300 and the noise symbol 116. Moreover, a noise function corresponding to a linear grid for FIG. 10, a conical grid for FIG. 11 and a plasma grid for FIG. 12 is selected and applied to determine the initial value (original or offset) for each pixel. As the views are generated the luminance varies uniformly for all pixels, however, as the initial values are offset by the shape of the noise function, in the resulting animation it appears as if a wave is moving across the grid.

The above discussed four examples, (FIG. 5—Plane, FIG. 10—Sweep, FIG. 11—Conical and FIG. 12—Plasma), may be further appreciated with respect to the following pseudocode. The noise function provides a grid that is the size of the resulting image. More specifically the noise function is sized to provide a grid that is about the same as grid 700, shown in FIG. 7 and discussed above. An iteration is then performed for each pixel, setting the value of each to the result a selected function. For example, to initialize the sweep embodiment as depicted in FIG. 10, Function 1 is appropriate, wherein y is the current row and h is the total number of rows.

$$offset = sin ( 2 π \times \frac{y}{h} ) \qquad Function 1$$

Function 1 will return values between −1 and 1 which are used to offset the initial color of each pixel of each grid along it's color cycle (black→grey→white→grey→black). To provide Conical or Plasma variations alternative functions are applied to determine the initial offset vales. Moreover, the pseudo code is as follows:

```
select symbol grid
select decoy grid
select initial noise function grid {e.g., Function 1 as shown above)
initialize_grid( symbol grid, noise grid )
initialize_grid( decoy grid, noise grid )
generate_views( )
sub initialize_grid( grid, noise grid )
    for each pixel
        if foreground pixel
            offset toward background color by noise grid offset
        else
            offset toward foreground color by noise grid offset
end sub
sub generate_views( )
    for each view
        for each pixel
          change luminance slightly in appropriate direction
            if pixel has been through a whole color cycle
                if currently at transition/grey value
                    if currently using symbol grid
                        switch to decoy grid
                    else
                        switch to symbol grid
end sub
```

To initialize the Conical embodiment variation as depicted in FIG. 11, Function 2 is appropriately substituted for Function 1 above. In Function 2, y is the current row, h is the total number of rows, x is the current column and w is the total number of columns.

$$offset = \sqrt{{( \frac{y}{h} )}^{2} + {( \frac{x}{w} )}^{2}} \qquad Function 2$$

As with Function 1, Function 2 will return values between −1 and 1 which are used to offset the initial color of each pixel of each grid along it's color cycle (black→grey→white→grey→black).

The Plasma embodiment as illustrated by FIG. 12 is provided in at least one embodiment with the use of a recursive algorithm to achieve random midpoint displacement. As the technique is recursive, it is most easily described with a pseudo code example as opposed to an expressed function equation as in the case of Function 1 and Function 2. Moreover, for a Plasma embodiment, the grid g has a height h and a width w. For each pixel the initial offset may be determined in according with the following pseudo code:

```
set corner colors c1, c2, c3, c4 to random (c here is short for
corner, not color)
divide( g, h, w, c1, c2, c3, c4 )
sub divide( g, h, w, c1, c2, c3, c4 )
{
    h′ = h / 2
    w′ = w / 2
    if h′ * w′ is bigger than a pixel
    {
    set middle pixel color equal to average of four corners
    plus random displacement
        m = ( ( c1 + c2 + c3 + c4 ) / 4 ) + random
        set pixel color in the middle of each edge equal to the
        average of its two corners
        e1 = ( c1 + c2 ) / 2
        e2 = ( c2 + c3 ) / 2
        e3 = ( c3 + c4 ) / 2
        e4 = ( c4 + c1 ) / 2
        define four new grid quarter sections g1, g2, g3 & g4 by one of
        the original corners, the middle pixel and the middle of each
        edge
        recursively call this function with each grid quarter using its
        respective corner colors
        divide( g1, h′, w′, c1, e1, m, e4 )
        divide( g2, h′, w′, e1, c2, e2, m )
        divide( g3, h′, w′, m, e2, c3, e3 )
        divide( g4, h′, w′, e4, m, e3, c4 )
    }
    else
    {
        set pixel color equal to average of four surrounding corners
        c = ( c1 + c2 + c3 + c4 ) / 4
    }
}
```

Indeed, for the varying embodiments illustrated in FIGS. 10, 11 and 12 the multiple apparent bounded areas and disappearing and reappearing elements of each symbol significantly increase the challenge posed by the views of the representation symbol 300 and the noise symbol 116 when perceived by a bot or other automated agent. Just the same, the human mind is capable of quickly abstracting each view to perceive the representations for the base image symbol 1000, that of the characters “WJK7T1”.

With respect to FIGS. 3, 5 and 7-12 it is understood and appreciated that each and every part of the displayed view transitions through the entire range of the applied visual property. A common action employed in attempting to crack CAPTCHA representations is often to superimpose multiple images, if not all the images upon one another with the expectation that the embedded information will be more clearly revealed. SGSIC 100 and/or method 200 is advantageously impervious to such action as a compilation of the generated views, if not all of the views will simply result in a composite image wherein all areas exhibit the extreme visual property applied (e.g., black color, extreme illumination, extreme contrast, or other property).

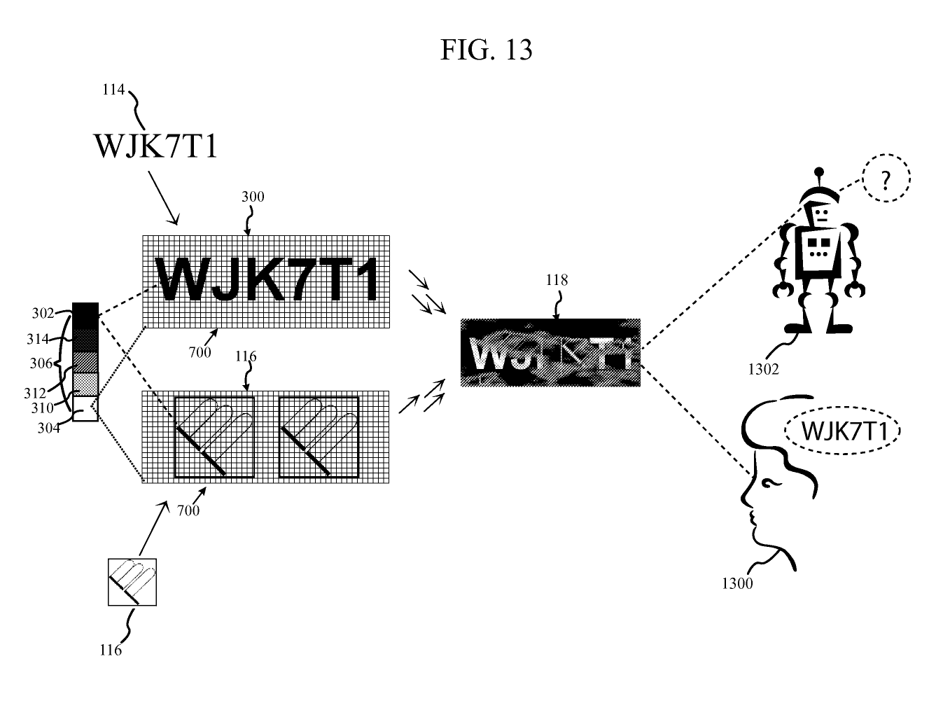

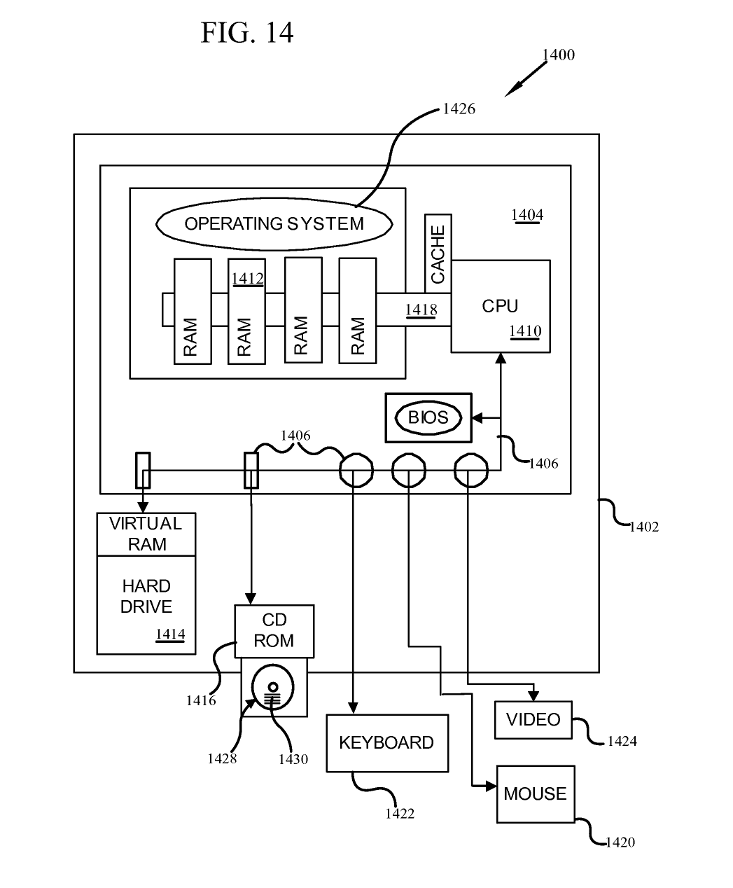

FIG. 13 conceptually summarizes the above discussion. More specifically, a base symbol 114, e.g., “WJK7T1” is provided. A representation symbol 300 is generated by applying a first foreground property and a first background property to the base symbol. A noise symbol 116 is selected. The noise symbol has a second foreground property and a second background property. As discussed above, the property in at least one embodiment is that of color, the foreground and background colors providing a range 306.

A plurality of views is then generated by transitioning between the representation symbol 300 and the noise symbol 116. More specifically, in at least one embodiment, the representation symbol 300 and the noise symbol 116 are pixelated by a grid 700 so as to define common pixels. Each pixel in each symbol is then transitioned throughout the range 306.

A plurality of views is then generated as an animation. The resulting views as animation are perceived by a human 1300 and understood to be representations of the initial base symbol, e.g., “WJK7T1”. The human 1300 will also likely understand the representations of the noise symbol, but be able to discern the noise symbol from the intended base symbol. If the same views are perceived by an automated agent 1302, the complexity of the transition of each symbol and the composite image view of the combined transitions is confounding. In other words the resulting views are human only perceptible (HOP), and pose an advantageous challenge to an automated agent 1302.

With respect to the above description of SGSIC 100 and method 200, it is understood and appreciated that the method may be rendered in a variety of different forms of code and instruction as may be preferred for different computer systems and environments. To expand upon the initial suggestion of a computer implementation suggested above, FIG. 14 is a high level block diagram of an exemplary computer system 1400. Computer system 1400 has a case 1402, enclosing a main board 1404. The main board has a system bus 1406, connection ports 1408, a processing unit, such as Central Processing Unit (CPU) 1410 and a memory storage device, such as main memory 1412, hard drive 1414 and CD/DVD ROM drive 1416.

Memory bus 1418 couples main memory 1412 to CPU 1410. A system bus 1406 couples hard drive 1414, CD/DVD ROM drive 1416 and connection ports 1408 to CPU 1410. Multiple input devices may be provided, such as for example a mouse 1420 and keyboard 1422. Multiple output devices may also be provided, such as for example a video monitor 1424 and a printer (not shown).

Computer system 1400 may be a commercially available system, such as a desktop workstation unit provided by IBM, Dell Computers, Gateway, Apple, Sun Micro Systems, or other computer system provider. Computer system 1400 may also be a networked computer system, wherein memory storage components such as hard drive 1414, additional CPUs 1410 and output devices such as printers are provided by physically separate computer systems commonly connected together in the network. Those skilled in the art will understand and appreciate that physical composition of components and component interconnections comprising computer system 1400, and select a computer system 1400 suitable for the schedules to be established and maintained.

When computer system 1400 is activated, preferably an operating system 1426 will load into main memory 1412 as part of the boot strap startup sequence and ready the computer system 1400 for operation. At the simplest level, and in the most general sense, the tasks of an operating system fall into specific categories—process management, device management (including application and user interface management) and memory management.

In such a computer system 1400, the CPU 1410 is operable to perform one or more of the methods of representative symbol generation described above. Those skilled in the art will understand that a computer-readable medium 1428 on which is a computer program 1430 for generating representation symbols may be provided to the computer system 1400. The form of the medium 1428 and language of the program 1430 are understood to be appropriate for computer system 1400. Utilizing the memory stores, such as for example one or more hard drives 1414 and main system memory 1412, the operable CPU 1402 will read the instructions provided by the computer program 1430 and operate to perform the scheduling system 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method of generating a symbol identification challenge for an automated agent, the method comprising:
receiving a plurality of symbols;
for each received symbol, applying a first visual property and a second visual property to the symbol;
transforming each received symbol by, for each received symbol, transitioning the first visual property to the second visual property and the second visual property to the first visual property; and
generating a plurality of views by transitioning between the transformations of each received symbol.

2. The method of claim 1, wherein at least one received symbol is a base symbol and at least one received symbol is a noise symbol.

3. The method of claim 2, wherein the noise symbol is received from a user and the noise symbol is selected from a database.

4. The method of claim 1, wherein in a first instance the first visual property is a foreground color and the second visual property is a background color, and in a second instance the first visual property is a contrast value and the second visual property is a contrast value.

5. The method of claim 1, wherein for all received symbols the first and second visual properties are about the same.

6. The method of claim 1, wherein for at least two received symbols the first and second visual properties are different.

7. The method of claim 1, further including applying a grid to each received symbol, the grid defining common pixel locations for each symbol.

8. The method of claim 1, wherein the method is stored on a computer-readable medium as a computer program which, when executed by a computer will perform the steps of generating a representation of a symbol, the generated symbol posing a challenge for an automated agent.

9. The method of claim 1, wherein the plurality of views are human only perceptible (HOP).

10. A method of generating a symbol identification challenge for an automated agent, the method comprising:
receiving a base symbol;
generating a representation symbol by applying a first foreground property and a first background property to the base symbol;
selecting at least one noise symbol, the noise symbol having a second foreground property and a second background property;
generating a plurality of views by:
transforming the representation symbol by transitioning the first foreground property to the first background property and the first background property to the first foreground property;
transforming the noise symbol by transitioning the second foreground property to the second background property and the second background property to the second foreground property; and
combining the transition of the representation symbol with the transition of the noise symbol.

11. The method of claim 10, wherein the first foreground property is a first foreground color, the first background property is a first background color, the second foreground property is a second foreground color, and the second background property is a second background color.

12. The method of claim 10, wherein the first foreground property is a first foreground contrast value, the first background property is a first background contrast value, the second foreground property is a second foreground contrast value, and the second background property is a second background contrast value.

13. The method of claim 10, wherein the first foreground property is a first foreground luminance value, the first background property is a first background luminance value, the second foreground property is a second foreground luminance value, and the second background property is a second background luminance value.

14. The method of claim 10, wherein the first foreground property is about equal to second background property and the first background property is about equal to the second foreground property.

15. The method of claim 10, wherein the first foreground property is about equal to second foreground property and the first background property is about equal to the second background property.

16. The method of claim 10, wherein as each symbol is transformed the transition of foreground to background property passes through a midpoint wherein the foreground and background properties are about equal, a cycle of transition for each symbol being measured from the midpoint.

17. The method of claim 16, wherein the transition of the representation symbol is a first stream and the transition of the noise symbol is a second stream.

18. The method of claim 17, wherein combining the transitions contemporaneously shows the first and second streams superimposed together.

19. The method of claim 17, wherein combining the transitions cycles from the first stream to the second stream at respective midpoints.

20. The method of claim 10, further including applying a grid to both the representation symbol and the noise symbol, the grid defining common pixel locations for each symbol.

21. The method of claim 20, wherein for the representation symbol each pixel is initially set to either the foreground property or the background property, and wherein for the noise symbol each pixel is initially set to either the foreground property or the background property, the foreground property and background property defining a property range.

22. The method of claim 21, wherein each pixel transitions throughout the color range in accordance with a function.

23. The method of claim 21, wherein the function is selected from the group consisting of: a sine function, a fractal function, a chaotic function, a pseudo random, a random, a linear, a non-linear function and/or combinations thereof.

24. The method of claim 21, wherein transforming each symbol is performed by, for each symbol, contemporaneously transitioning the property of all pixels incrementally.

25. The method of claim 21, wherein transforming each symbol is performed by, for each symbol, transitioning the property of each pixel incrementally in a pattern.

26. The method of claim 25, wherein the pattern is a defined pattern selected from the group consisting of: from left to right, right to left, top to bottom, bottom to top, the outside in, the inside out, diagonally and/or combinations thereof.

27. The method of claim 25, wherein the pattern is selected from the group consisting of: a random, fractal, chaotic, pseudo-random, random, linear, non-linear and/or combinations thereof.

28. The method of claim 25, wherein the pattern is achieved by applying a function adapted to return values within a predetermined range corresponding to the grid, the function selected from the group consisting of: a sine function, a conical function, a plasma function, a fractal function, a pseudo-random function, a random function, a linear function, a non-linear function and/or combinations thereof.

29. The method of claim 10, further including selecting at least one second noise symbol, the second noise symbol having a third foreground property and a third background property, the generation of views further including:
transforming the second noise symbol by transitioning the third foreground property to the third background property and the third background property to the third foreground property; and
combining the transition of the second noise symbol with the transition of the representation symbol and the transition of the noise symbol.

30. The method of claim 10, wherein the method is stored on a computer-readable medium as a computer program which, when executed by a computer will perform the steps of generating a representation of a symbol, the generated symbol posing a challenge for an automated agent.

31. A method of generating a symbol identification challenge for an automated agent, the method comprising:
receiving a base symbol;
generating a representation symbol by imposing a pixel grid upon the base symbol, each pixel receiving an initial value as foreground or background;
receiving at least one noise symbol and imposing the pixel grid upon the noise symbol, each pixel having an initial value as foreground or background;
generating a first stream by transitioning each pixel in the representation symbol through a value range defined by the foreground and the background;
generating a second stream by transitioning each pixel in the noise symbol through a value range defined by the foreground and the background; and
generating a plurality of views by combining the first stream and the second stream.

32. The method of claim 31, wherein the initial value as foreground is a first color and the initial value as background is a second color, the range being a color range defined by the first color and the second color.

33. The method of claim 31, wherein the initial value as foreground is a first luminance value and the initial value as background is a second luminance value, the range being a luminance range defined by the first luminance value and the second luminance value.

34. The method of claim 31, wherein combining the transitions contemporaneously shows the first and second streams superimposed together.

35. The method of claim 31, wherein the value of each pixel within the range is determined by a function selected from the group consisting of: a sine function, a fractal function, a chaotic function, a pseudo random, a random, a linear, a non-linear function and/or combinations thereof.

36. The method of claim 31, wherein each pixel transitioning through the range passes through a midpoint, the cycle of transition for each symbol being measured from the midpoint.

37. The method of claim 36, wherein combining the transitions cycles from the first stream to the second stream at respective midpoints.

38. The method of claim 37, wherein for each symbol the value of all pixels are contemporaneously transitioned incrementally.

39. The method of claim 38, wherein for each symbol the values of the pixels are transitioned incrementally in a pattern.

40. The method of claim 39, wherein the pattern is a defined pattern selected from the group consisting of: from left to right, right to left, top to bottom, bottom to top, the outside in, the inside out, diagonally and/or combinations thereof.

41. The method of claim 39, wherein the pattern is selected from the group consisting of: a random, fractal, chaotic, pseudo-random, random, linear, non-linear and/or combinations thereof.

42. The method of claim 41, wherein the pattern is by applying a function adapted to return values within a predetermined range corresponding to the grid, the function selected from the group consisting of: a sine function, a conical function, a plasma function, a pseudo-random function, a random function, a linear function, a non-linear function and/or combinations thereof.

43. The method of claim 31, further including at least one second noise symbol, each second noise symbol having the pixel grid imposed thereon, each pixel receiving an initial value as foreground or background, and generating for each second noise symbol a third stream by transitioning each pixel in each second noise symbol through a value range defined by the foreground and the background.

44. The method of claim 31, wherein the method is stored on a computer-readable medium as a computer program which, when executed by a computer will perform the steps of generating a representation of a symbol, the generated symbol posing a challenge for an automated agent.

45. A system for generating a symbol identification challenge for an automated agent, the system comprising:
a receiver structure and arranged with an input device for permitting at least one first symbol to be received;
a database providing at least one second symbol;
an initializer structured and arranged to initialize each first and second symbol by applying to each symbol a foreground property and a background property;
a transitioner structured and arranged to transition each symbol between the foreground property and the background property; and
a view generator structured and arranged to generate a plurality of views by combining the transitions of the symbols.

46. The system of claim 45, wherein in a first instance the foreground and background image properties are each a respective color, and in a second instance the foreground and background image properties are each a respective contrast value selected from a luminance range.

47. The system of claim 45, wherein the initializer includes a grid structured and arranged to define common pixel locations for each first and second symbol.

48. A computer-readable medium on which is stored a computer program for generating a representation of a symbol as a challenge for an automated agent, the computer program comprising instructions which when executed by a computer, perform the steps of:
receiving a plurality of symbols;
for each received symbol, applying a first visual property and a second visual property to the symbol;
transforming each received symbol by, for each received symbol, transitioning the first visual property to the second visual property and the second visual property to the first visual property; and
generating a plurality of views by transitioning between the transformations of each received symbol.
